(19) United States
(12) Patent Application Publication
(10) Pub. No.: US 2006/0143112 A1
(43) Pub. Date: Jun. 29, 2006

(54) Dealer-located vehicle refinance system and method

(76) Inventors: David Donarski, Onalaska, WI (US); Thomas P. Wirth, Cincinnati, OH (US)

Correspondence Address: FOLEY & LARDNER LLP, 150 EAST GILMAN STREET, P.O. BOX 1497, MADISON, WI, 53701-1497, US

(21) Appl. No.: 11/024,229

(22) Filed: Dec. 28, 2004

(51) Int. Cl. G06Q 40/00

(52) U.S. Cl. 705/38

(57) ABSTRACT

A system and method relates to refinancing a vehicle at a vehicle dealer location. The method can include obtaining vehicle information at a dealer location for a vehicle that is financed to an owner with a first loan, providing a promissory note and security agreement for a second loan on the vehicle at the dealer location, obtaining a proof of payoff at the dealer location for the first loan, and completing a title application at the dealer location where the title application includes a financial institution as a lien holder on the second loan.

### BACKGROUND OF THE INVENTION

1. Field of the Invention

The present invention relates generally to systems and techniques for vehicle refinancing. More particularly, the present invention relates to a dealer-located vehicle refinance system and method.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Historically, the submission of loan applications from customers has been performed using paper forms that require personnel to manually input data into a computer at a financial institution, such as a bank or a credit union. Traditional credit approval processes have been highly inefficient and time consuming because the processing of these paper forms is very labor intensive and requires a visit or communication to a financial institution. Attempts have been made to improve efficiency and response through on-line type credit authorization systems. For example, IBM's AutoLoan Exchange (ALX) and Credit Management Solutions', Inc. (CMSI) Credit Corporation are automotive credit application services which coordinate loan application information between multiple institutions. Such systems are designed to allow the transmission of credit application information from a dealer location to various financial institutions as well as transmission of responses from the financial institutions back to the dealer.

A number of patents and published patent applications describe different systems for financing vehicle purchases. For example, U.S. Pat. No. 6,587,841 and U.S. Patent Application 2004/0138994 describe a credit application and routing system between automobile dealerships and lenders to provide an on-line, real time system for the indirect loan application process and funding. U.S. Patent Application 2002/0116328 describes a system that generates documents to produce a binding legal contract for a loan or lease.

While such systems have generally improved vehicle loan application efficiency and processing time, they suffer from several drawbacks, such as requiring the installation of unique and specific computer hardware at the dealership location. These systems also only provide for financing of the purchase of a vehicle. Customers visiting an automobile dealer may desire to obtain more favorable financial conditions for a vehicle they already own. However, currently such a refinance cannot be done at a dealer's location. As a result, the dealer misses an opportunity to develop a new client or improve a relationship with an existing client. Such new clients or existing clients could later return to purchase a new or used vehicle from the dealer. Expanded and more flexible services provide increased goodwill with customers.

Automobile dealers do conduct transactions referred to as “trade-ins” where a customer “trades” or sells a vehicle he or she owns to a dealership. Generally, the funds from this sale are applied towards the purchase of a new vehicle from the dealership. An automobile dealer could theoretically sell the customer back the car that he or she traded in to get the benefit of more favorable financing terms. However, such a trade-in and buy transaction would place the traded-in vehicle in the dealer inventory and the purchase back would include sales tax to the customer, negating any benefits from obtaining a better interest rate on the car loan.

There is a need to have a dealer-located vehicle refinance system and method. Further, there is a need to provide customers of an automobile dealer with financing options on vehicles after the vehicle is purchased. Even further, there is a need to improve vehicle financing procedures.

### SUMMARY OF THE INVENTION

One exemplary embodiment relates to a method for refinancing a vehicle at a vehicle dealer location. The method can include obtaining vehicle information at a dealer location for a vehicle that is financed to an owner with a first loan, providing a promissory note and security agreement for a second loan on the vehicle at the dealer location, obtaining a proof of payoff at the dealer location for the first loan, and completing a title application at the dealer location where the title application includes a financial institution as a lien holder on the second loan.

Another exemplary embodiment relates to a system for refinancing a vehicle at a vehicle dealer location. The system includes a computer user interface, a communication interface, and a processor. The computer user interface is configured for entering vehicle information for a vehicle that is financed to an owner with a first loan and owner information. The computer user interface is presented on a dealer computer is located at a dealer location. The communication interface facilitates communication between the dealer computer and a financial institution. The financial institution communicates approval for a refinancing operation for the vehicle. The processor executes instructions on the dealer computer to carry out the refinancing operation at the dealer location. The financial institution becomes a lien holder on a second loan for the vehicle.

Another exemplary embodiment relates to a method of refinancing a vehicle loan at a dealer location. The method can include providing a financial institution with a proposed loan term, customer credit information, and vehicle information from a dealer location for a refinance transaction for a vehicle; providing a promissory note and a security agreement at the dealer location; receiving approval of the refinance transaction for the vehicle from the financial institution at the dealer location; and communicating the executed promissory note and security agreement to the financial institution.

### BRIEF DESCRIPTION OF DRAWINGS

FIG. 1 is a general diagram depicting a dealer-located vehicle refinance system in accordance with an exemplary embodiment.

FIG. 2 is a flow diagram depicting operations performed in a dealer-located vehicle refinance process in accordance with an exemplary embodiment.

FIG. 3 is a general diagram depicting a dealer-located vehicle refinance system in accordance with an exemplary embodiment.

FIG. 4 is a flow diagram of operations performed at an automobile dealer location in a vehicle refinance process in accordance with an exemplary embodiment.

### DETAILED DESCRIPTION OF EXEMPLARY EMBODIMENTS

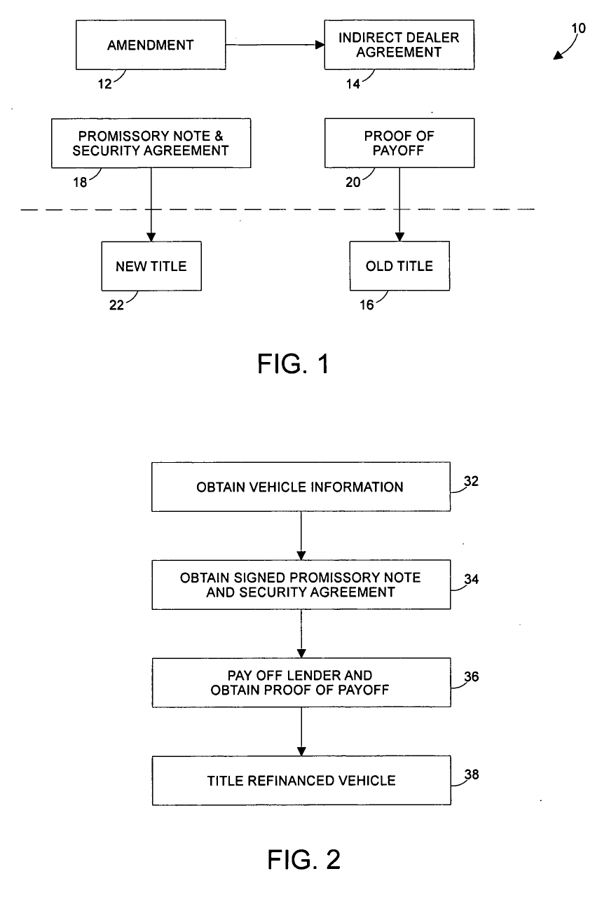

FIG. 1 illustrates a dealer-located vehicle refinance system 10 in accordance with an exemplary embodiment. Using the dealer-located vehicle refinance system 10, a dealer can develop a new customer base to enter the dealer location and potentially purchase a new vehicle. Some customers may not be able to purchase another vehicle without conducting a refinancing transaction on an existing vehicle. Refinancing at the dealer location also helps develop goodwill with existing customers and future customer who return later after the refinancing transaction and purchase a vehicle. The dealer-located vehicle refinance system 10 includes an amendment 12 to an indirect dealer agreement 14. The indirect dealer agreement 14 is an agreement between a vehicle dealership and a financial institution that the vehicle dealership can carry out financing transactions for vehicles purchased at the dealership. The amendment 12 enables the dealer to carry out re-financing operations for vehicles that are not part of the dealership inventory. The re-financing operations involve obtaining an old title 16 for the vehicle to be re-financed. The old title 16 includes information regarding the lender to whom money is owned on a loan used to purchase the vehicle. If the vehicle owner agrees to the refinancing terms, the dealer obtains a signed promissory note and security agreement 18 from the owner.

The dealer obtains a proof of payoff 20 that the lender who is recorded on the old title 16 as the finance company for the current vehicle loan has received payment for the balance of the loan. Payoff of the current vehicle loan can be made using funds obtained from the re-financing operation. Such a proof of payoff 20 can be an electronic message or other type of confirmation that the dealer has sent payment to the lien holder. A new title 22 is obtained that includes a notification of the new financing entity.

FIG. 2 illustrates a flow diagram depicting operations performed in a dealer-located vehicle refinance process. Additional, fewer, or different operations may be performed depending on the embodiment. In an operation 32, the dealer obtains vehicle information, such as the vehicle identification number (VIN), the vehicle made, model, year of manufacture, and the condition of the vehicle. The dealer can also obtain owner information, such as owner name, address, drivers license number, and social security number. In an operation 34, the dealer obtains a signed promissory note and security agreement for the new financing transaction. Advantageously, the person requesting the re-financing can sign these papers at the dealer location. There is no need to travel to a separate institution to obtain the financing.

In an operation 36, the dealer pays the existing loan on the vehicle to be re-financed and obtains a proof of payoff. The existing loan can be paid in a number of different ways. The dealer must receive a proof of payoff check or an ACH (automated clearing house) debit to the lender being paid off. In an operation 38, a title application is completed with the new financing institution listed as the lien holder. The dealer has responsibility for properly titling the refinanced vehicle and the liens on the title.

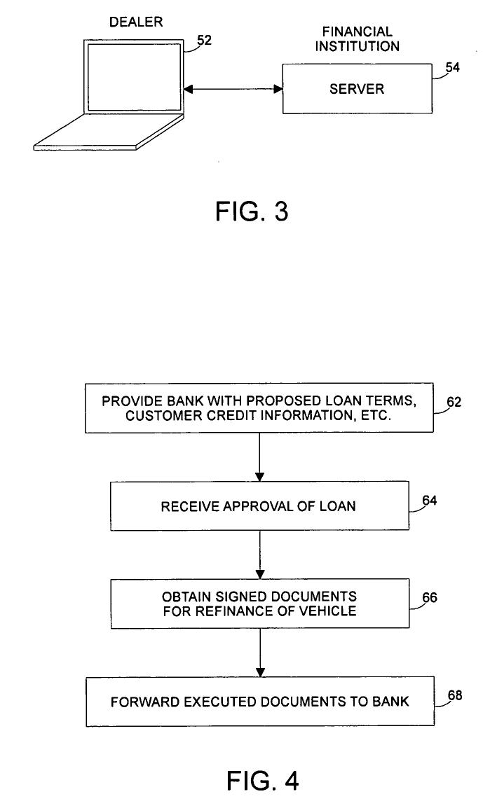

FIG. 3 illustrates a dealer-located vehicle refinance system 50 in accordance with another exemplary embodiment. In the dealer-located vehicle refinance system 50, the dealer utilizes a computer 52 to carry out re-financing operations. The computer 52 can be configured with software that requests necessary information to perform the re-finance operation. The computer 52 can be in communication with a server computer 54 at a financial institution, such as a bank or a credit union, that is the lien holder on the vehicle to be re-financed. The computer 52 and the server computer can be in communication via the Internet. The server computer 54 can store software and information to facilitate the re-financing operation. The connection between the computer 52 and the server computer 54 can be maintained continuously or, alternatively, the connection can be established periodically, such as once a day or once an hour.

FIG. 4 illustrates a flow diagram of operations performed at an automobile dealer location in a vehicle refinance process. Additional, fewer, or different operations may be performed depending on the embodiment. In an operation 62, the dealer provides a bank with a proposed loan term, customer credit information, and other relevant information for a finance transaction for a vehicle to refinance. In an operation 64, the dealer receives approval of the loan for the vehicle. Conditions for loan approval can vary depending on a wide range of different factors. In an operation 66, the dealer procures documents for the refinance of the vehicle. Such documents can include a promissory note and a security agreement. The vehicle owner signs the documents to obtain new financing terms for his or her vehicle. In an operation 68, the executed documents are sent electronically to the bank. The dealer properly titles the refinanced vehicle by filing a title application including the bank as a lien holder.

While several embodiments of the invention have been described, it is to be understood that modifications and changes will occur to those skilled in the art to which the invention pertains. For example, a refinancing system for vehicles has been described that enables vehicle owners to refinance vehicles. The refinance system can also identify and process refinancing for other things, such as houses. Accordingly, the claims appended to this specification are intended to define the invention precisely.

What is claimed is:

1. A method for refinancing a vehicle at a vehicle dealer location, the method comprising:
obtaining vehicle information at a dealer location for a vehicle that is financed to an owner with a first loan;
providing a promissory note and security agreement for a second loan on the vehicle at the dealer location;
obtaining a proof of payoff at the dealer location for the first loan; and
completing a title application at the dealer location where the title application includes a financial institution as a lien holder on the second loan.

2. The method of claim 1, wherein obtaining a proof of payoff at the dealer location for the first loan comprises receiving an indication of an automated clearing house (ACH) debit.

3. The method of claim 1, further comprising obtaining vehicle owner information at the dealer location for the vehicle that is financed to the owner.

4. The method of claim 1, further comprising providing the financial institution with proposed loan term and credit information for the owner of the vehicle at the dealer location.

5. The method of claim 4, further comprising receiving approval at the dealer location for refinancing the vehicle from the financial institution.

6. The method of claim 1, further comprising requesting proposed loan terms from the financial institution.

7. The method of claim 1, further comprising communicating executed refinance documents to the financial institution.

8. The method of claim 1, further comprising further comprising providing the financial institution with vehicle information and credit information for the owner of the vehicle at the dealer location.

9. A system for refinancing a vehicle at a vehicle dealer location, the system comprising:
a computer user interface for entering owner information and vehicle information for a vehicle that is financed to an owner with a first loan, wherein the computer user interface is presented on a dealer computer located at a dealer location;
a communication interface that facilitates communication between the dealer computer and a financial institution, wherein the financial institution communicates approval for a refinancing operation for the vehicle; and
a processor that executes instructions on the dealer computer to carry out the refinancing operation at the dealer location, wherein the financial institution becomes a lien holder on a second loan for the vehicle.

10. The system of claim 9, wherein the dealer computer communicates a proof of payoff for the first loan to the financial institution.

11. The system of claim 10, wherein the proof of payoff is an automated clearing house (ACH) debit.

12. The system of claim 9, further comprising a printer that provides documentation for a second loan on the vehicle at the dealer location.

13. The system of claim 9, wherein the dealer computer communicated proposed loan term and credit information to the financial institution.

14. The system of claim 9, wherein the dealer computer receives credit information for the owner of the vehicle.

15. A method of refinancing a vehicle loan at a dealer location, the method comprising:
providing a financial institution with a proposed loan term, customer credit information, and vehicle information from a dealer location for a refinance transaction for a vehicle;
providing a promissory note and a security agreement at the dealer location;
receiving approval of the refinance transaction for the vehicle from the financial institution at the dealer location; and
communicating the executed promissory note and security agreement to the financial institution.

16. The method of claim 15, further comprising communicating proof of payoff information to the financial institution from the dealer location.

17. The method of claim 15, further comprising completing a title application where the financial institution is a lien holder.

18. The method of claim 15, wherein the vehicle information comprises a vehicle identification number (VIN) and a condition of the vehicle.
